(19) United States
(12) Patent Application Publication
(10) Pub. No.: US 2021/0396291 A1
(43) Pub. Date: Dec. 23, 2021

(54) COATING, IN PARTICULAR FOR BRAKE DISCS, BRAKE DRUMS AND CLUTCH DISCS, BRAKE DISC FOR A DISC BRAKE OR BRAKE DRUM FOR A DRUM BRAKE OR CLUTCH DISC FOR A CLUTCH, DISC BRAKE OR DRUM BRAKE OR CLUTCH, METHOD FOR PRODUCING A COATING IN PARTICULAR FOR BRAKE DISCS, BRAKE DRUMS AND CLUTCH DISCS, AND USE OF A COATING

(71) Applicant: Höganäs AB (Publ), Höganäs (SE)

(72) Inventor: Benno GRIES, Wolfenbüttel (DE)

(73) Assignee: Höganäs AB (Publ), Höganäs (SE)

(21) Appl. No.: 17/292,776

(22) PCT Filed: Dec. 13, 2019
(86) PCT No.: PCT/EP2019/085093

§ 371 Date: May 11, 2021

(30) Foreign Application Priority Data
Dec. 14, 2018 (DE) 20 2018 107 169.6

(51) Int. Cl. F16D 69/02; C23C 4/06

(52) U.S. Cl. CPC F16D 69/027; C23C 4/06; F16D 2069/003; F16D 2200/0026; F16D 2250/0046

(57) ABSTRACT

The present invention comprises a coating, in particular for brake discs, brake drums and clutch discs, and also a brake disc for a disc brake or a brake drum for a drum brake or a clutch disc for a clutch, a disc brake or drum brake or clutch itself and also a method for producing a coating in particular for brake discs, brake drums and clutch discs, and the use of a coating. The coating has a first layer, which comprises a metal-based material, which contains less than 20% by weight tungsten carbide or other carbides, and a second layer, which is applied to the first layer and comprises a tungsten-carbide-containing material, which contains 20% by weight to 94% by weight tungsten carbide, wherein the first and the second layers are thermally sprayed coatings.

### TECHNICAL FIELD

The present invention relates to a coating, in particular for brake discs, brake drums and clutch discs, and also to a brake disc for a disc brake or a brake drum for a drum brake or a clutch disc for a clutch, further to a disc brake or drum brake or clutch, to a method for producing a coating in particular for brake discs, brake drums and clutch discs, and finally to the use of a coating.

### BACKGROUND OF THE INVENTION AND PRIOR ART

Disc brake systems consist, inter alia, of rotating discs, mostly made of cast iron, steel or light metals. Said discs (“brake discs”) wear by the braking operation, with the material condition of the friction linings (“brake linings”) playing a role. The more ceramic fillers said linings have, the higher generally is the wear of the friction surface of the brake disc. Therefore, brake linings usually contain more metallic fillers than ceramic. For reasons of durability of brake linings and for reasons of reducing the emissions of metal-containing dust arising during the braking operation, attempts are being made to increase the proportion of ceramic in brake linings as much as possible, which however is at the expense of the service life of the brake disc as a friction partner, which brake disc experiences correspondingly higher frictional wear as a result. For this reason, it is the state of the art to provide brake discs with wear-reducing coatings.

Promising coating materials are those which contain a high proportion of tungsten carbide (WC). Said coatings are applied by means of the method of thermal spraying, usually by means of the HVOF method (“High Velocity Oxygen Fuel”). The proportion of WC is primarily determinative of the wear resistance. Further constituents (6 to 80%) are typically mainly metals of the group Fe, Co, Ni and Cr and also the alloys thereof and the carbides thereof. In rare cases, further metals may also be present, for example, Al, Mo, Cu, Mn, B or Si. As a result of the metallurgical changes during thermal spraying, the coatings additionally contain proportions of M6C carbides and/or oxides, for example Cr oxide, less rarely also W2C. The proportion by weight of tungsten carbide in the coating material (i.e. in the spray powder used for coating) is between 20 and 94%.

Notably, coatings made of WC-containing coating materials have substantially lower coefficients of thermal expansion than Fe- or Al-based materials. The more WC present, the lower, inter alia, the coefficient of thermal expansion. However, since, for example, brake discs are thermally loaded in a cyclical manner and must even withstand thermal shock, stresses occur between the brake disc and its coating during temperature changes, and therefore the latter can become cracked or even burst and consequently loses its function. Tungsten carbide has a modulus of elasticity of about 700 GPa, while iron-based materials are in the range of approximately 200 GPa. This can lead to the build-up of considerable stresses between coating and brake disc during temperature changes.

A further requirement of the brake disc coating is that, in use, it does not have any cracks which lead down as far as the brake disc. Such cracks (or also continuously connected porosity) lead to crevice corrosion, in particular under the influence of chloride ions, which can originate from the use of gritting salt. The known WC-containing coating materials therefore do not satisfy the aforementioned requirements for the corrosion protection, for example, of a brake disc. For reasons of the necessary corrosion protection, it is state of the art to coat the brake disc galvanically with Ni prior to the coating, before it is coated with a WC-containing coating material by means of the HVOF method. However, the galvanization involves a complex, additional production step in another production line, accompanied by washing, drying, transporting and handling. The useful material spectrum of the galvanic coating is also very restricted and is limited to nickel and copper. Further, galvanically deposited coatings are often under tensile stresses, which in this case is unfavorable because of the tendency to crack.

With the known thermal spraying methods, coating materials and coating systems, currently no friction protection coating can be produced which meets all requirements at the same time. In particular, there is none which offers efficient friction protection, is durable, has a high temperature change resistance and thermal shock resistance, and reliably protects against corrosion and thus prevents crevice corrosion.

The object and aim of the present invention is therefore to overcome the problems in the prior art described above. In particular, it is an object and an aim of the present invention to provide a powerful coating for tribologically loaded components, in particular for components in the automotive sector, which protects the components from frictional wear and corrosion, lengthens their service life and which itself is particularly durable. A further object and a further aim of the present invention are the provision of corresponding components with the advantageous coating and the provision of systems containing such components and, finally, the use of the coating for coating such components.

### LIST OF DRAWINGS

FIG. 1 shows a microscopic cross-sectional image in the layer thickness direction (scale bar approximately 51 μm long) of the first layer of the coating according to the invention.

### DESCRIPTION OF THE INVENTION

The above objects are accomplished and the above aims are achieved by the subject matters of the attached independent and parallel claims, wherein the dependent claims define optional features and preferred embodiments.

The present invention relates to a coating, in particular suitable for brake discs, brake drums and clutch discs, but not restricted thereto, comprising

a first, preferably inner, layer, which comprises a metal-based material, which contains less than 20% by weight hardness carrier, in particular tungsten carbide (WC) or other carbides or oxides, and a second, preferably outer, layer, which is applied to the first layer and comprises a tungsten-carbide-containing material, which contains 20% by weight, preferably 40% by weight to 94% by weight, preferably 90% by weight tungsten carbide (WC), wherein

the first and second layers can be, and preferably are, thermally sprayed coatings. It should be noted that any desired combinations of the above range limits are included in the present disclosure, for example also WC content ranges of 20 to 40% by weight or 40 to 90% by weight and so on.

In the context of the present invention, “coating” is to be understood as meaning a material system which is applied to the surface, in particular the friction surfaces, of a base body, covering the surface, preferably entirely covering the surface, i.e. over the entire friction surface, in order to cover the latter. The base body can be formed, for example, by an automotive disc brake, an automotive brake drum, or an automotive clutch disc. For the purposes of the present invention, the first layer is first applied to the base body, thus making it an inner layer, and the second layer is applied thereover and thereon, thus making it an outer layer which comes into contact with the friction partner, e.g. the brake lining in a disc brake or the brake shoe of a drum brake or the driving disc in a friction clutch. In a preferred embodiment, the coating consists overall only of the first layer and the second layer and optionally further of the third layer described below. The coating according to the invention is therefore preferably two-layered or optionally three-layered.

The “metal-based material” as a constituent of the first layer is to be understood as a material that is predominantly formed by a metal or a metallic alloy, i.e., they form the base material or the main component. The metal or to the alloy can thereby form the matrix for the incorporation of any carbides present, in particular tungsten carbide, as hardness carriers or oxides and is thus the main component/base material of the metal-based material. According to the present invention, the content of carbides and/or oxides in the metal-based material is limited to a maximum content of 20% by weight inclusive, with any desired smaller values being included, including a content of 0% by weight. In other words, it is preferred that the content of hardness carriers, in particular of specifically added hardness carriers, for example tungsten carbide and/or chromium carbide (CrC) and/or silicon carbide (SiC), is reduced to a maximum content/maximum value of 20% by weight inclusive in the metal-based material. Accordingly, the metal-based material of the first layer can optionally and particularly preferably also be carbide-free or oxide-free or hard-substance-free and then consists exclusively of a metal or an alloy without intentionally added and functionally acting hardness carriers, except for hardness carriers which form unavoidably and which are to be regarded rather as impurities. It is preferred that the contents of the base material of the metal-based material (e.g. metal or alloy) and of carbides and oxides as well as unavoidable impurities add up to 100% by weight. It should further be noted that the oxides mentioned automatically arise during thermal spraying, for example, or originate from admixtures of aluminum oxide or chromium oxide.

The “tungsten-carbide-containing material” of the second layer is to be understood as a material which, in addition to tungsten carbide, also has at least one further component in the form of a metal or a metallic alloy. Depending on the content of the tungsten carbide, the second component may constitute the main component or the secondary component of the tungsten-carbide-containing material. It is optionally envisaged that the second component serves as a material matrix for the hardness carrier tungsten carbide. It is also included in the present invention and disclosure that the second layer optionally preferably comprises or consists of a different carbide-containing material instead of the tungsten-carbide-containing material, and further preferably a hard-substance-containing material. It is preferred that the contents of the tungsten carbide or of the hard substance in general and of the further component and unavoidable impurities add up to 100% by weight. In the context of this disclosure, the tungsten carbide content (WC) in coating materials and coatings is determined as follows: 94 parts by weight of tungsten are mathematically assigned 6 parts by weight of carbon. The sum of both calculated parts by weight results in the percentage WC content in the spray material or in the coating. Any excess carbon content is assigned, for example, to chromium or silicon of the metal-based material, which in this case would be present at least partially as carbide. The selected content range for tungsten carbide of 20% by weight inclusive up to 94% by weight inclusive is advantageous in that below 20% the wear protection is too low and above 94% the metallic matrix content is again too low in order to still impart sufficient strength to the layer.

The coating described above constitutes a novel, preferably two-layer coating system. In particular, it is envisaged that the first and second layers differ function-specifically, in particular in their carbide contents and tungsten carbide contents and in their structure or microstructure. In this case, the first layer consists predominantly of a metallic material, in order to be plastically deformable without cracking. The first layer thus preferably has a low deformation limit and a high elongation at break. The upwardly limited proportion of carbides serves to prevent the coefficients of thermal expansion from becoming too low, and also to allow plastic deformability for stress reduction. In addition, the material of the first layer is corrosion-resistant to gritting salt (NaCl-based). The object of the second layer is ensuring wear protection, which is achieved by an in part significantly increased proportion of hardness carriers, in particular tungsten carbide, in comparison with the first layer. Since the first layer also takes care of corrosion protection for the coated base body, the second layer can have pores and cracks, which is even positive since the stresses exerted on the first layer, which serves as a buffer layer, as well as on the base body during temperature changes, become lower as a result. Furthermore, pores and cracks even increase the thermal shock resistance of the second coating, which is relevant since there is the possibility that, for example, vehicles with hot brake discs can travel through puddles, thereby causing sudden temperature changes which can damage conventional coatings. Finally, cracks in the second coating are even conducive to the responsiveness of the brake in wet conditions. The two-layer coating thus enables advantageous decoupling of the two objects of “corrosion protection” and “avoiding stresses due to different coefficients of thermal expansion” on the one hand and “wear protection” on the other hand. The first layer therefore acts not only as a mechanical buffer layer, but additionally also constitutes a barrier layer which can shield the coated base body from corrosive media and thus suppresses crevice corrosion.

Advantageously, the first layer consists of the metal-based material and/or the second layer consists of the tungsten-carbide-containing material. This preferred embodiment is to be understood as meaning that the first layer and/or the second layer consist substantially of only one (composite) material. Specifically, the first layer thus consists only of the metal-based material, including any optional carbides and oxides, and the second layer consists only of the tungsten-carbide-containing material, including matrix material, and are substantially free of other materials which could co-exist in the layers. The positive effects described above can thus be maximized. Optionally, the metal-based material of the first layer and the tungsten-carbide-containing material of the second layer can also be characterized as composite materials since they can be constructed from at least two different materials, namely metal and ceramic hardness carriers (e.g. embedded in the metallic matrix in particle form). In particular, the second layer optionally has a cermet character. The first layer and the second layer then advantageously each consist of the corresponding composite material.

The feature “thermally sprayed layer” is to be understood here as meaning that the first and second layers are preferably obtainable or obtained by thermal spraying and are thermal spray layers. Technologically, the layers of the coating thus produced are layers which have conventionally been produced by means of HVOF, HVAF, “cold spray” or “warm spray” methods, i.e. high kinetic thermal spraying methods. In principle, thermal spray methods are described in DIN EN 657 (DIN EN 657:2005-06 “Thermal spraying—terminology, classification”), wherein the definitions made therein offer at least one general technical classification of the layers according to the invention and thus technically distinguish these from layers and coatings produced by other coating methods.

The protective effect of the first coating and the overall coating on corrosion can be verified, for example, by a salt spray test according to ASTM B 117 on the coating system. Preferably, the first layer or the coating overall is formed such that the coating has a service life of more than 1000 h in the salt spray test according to ASTM B 117. This advantageous property is caused structurally by the morphology of the first layer, which is free of pores and cracks, in particular continuous cracks and pores which extend as far as the base body, in such a way that it is virtually impermeable to corrosive media. The coated base body is thus protected particularly well from corrosion. The first layer consequently functions as a barrier layer.

The first (inner) layer of the coating according to the invention is advantageously a substantially dense, pore- and crack-free layer and the second layer of the coating according to the invention has cracks and pores which are continuous in the layer thickness direction. Quantitatively, these features are to be determined functionally. Free of cracks and pores accordingly also includes a layer in which a few pores and cracks are to be encountered as long as their number is so low that the viability of the first layer as a buffer layer, barrier layer and corrosion protection layer is ensured. The same applies with any continuous or open cracks and pores potentially present in the second layer, which are provided and present in terms of their number and nature in such a way that they bring about the above functionalities in particular with regard to the temperature and thermal shock resistance of the second layer. A cracked layer structure is particularly preferred with respect to the temperature-change resistance since it exerts fewer stresses on the first layer and on the brake disc due to its lower modulus of elasticity during temperature changes. As already described above, pores and cracks in the corresponding layer are even positive since, as a result, the stresses exerted on the first layer, which serves as buffer layer, and on the base body during temperature changes, are lower. Furthermore, pores and cracks even increase the thermal shock resistance of the second layer, which is relevant since there is the possibility that, for example, vehicles with hot brake discs can travel through puddles, but the sudden temperature changes caused thereby do not damage the coating. Finally, cracks in the second layer are even conducive to the responsiveness of the brake in wet conditions.

In a preferred embodiment of the coating according to the invention, the metal-based material of the first layer comprises iron (Fe) and/or nickel (Ni) and/or chromium (Cr) or preferably consists of iron and/or nickel and/or chromium. In addition to technically pure metals, this embodiment also includes technical alloys of the metals iron, nickel and chromium and alloys of these metals with one another. As has already been explained above, these metals or the alloys thereof form the main component of the metal-based material of the first layer and the material-based matrix for accommodating the optional hardness carriers, for example of tungsten carbide or oxides. Further suitable materials for the first layer or the metal-based material thereof are, for example, stainless steels such as AISI 316L, or FeCr 70/30, or stainless steels 1.4562, 1.4306, 1.4462 according to DIN, or NiCr 80/20 with 0.5% Si. Due to the desired resistance to corrosion by chloride ions, it is particularly preferred that the first layer or the metal-based material in any case contains Cr, preferably comprises at least 15% by weight chromium, or consists of pure Cr. Furthermore, the metal-based material of the first layer may also have impurities that are still unavoidable. The above choice of material is particularly advantageous in that the first layer can be plastically deformed without cracking and has a low deformation limit and a high elongation at break.

Separately or combinable with the above embodiment, it is preferred that the tungsten-carbide-containing material of the second layer comprises iron (Fe), cobalt (Co), nickel (Ni), chromium (Cr) and/or aluminum (Al) or alloys of these elements. This embodiment likewise comprises the listed elements/metals in pure form or technically pure, as well as technical alloys and also as alloys with one another. Particular preference is given to an Fe—Cr—Al alloy as constituent, i.e., secondary or main component, depending on the hardness carrier content of the tungsten-carbide-containing material of the second layer. The tungsten-carbide-containing material of the second layer may also comprise silicon (Si) and/or unavoidable impurities.

The first layer of the coating according to the invention is advantageously stably austenitic at room temperature, i.e. in the range from 18° C. to 22° C. This specifically means that only one face-centered cubic crystal lattice is found in X-ray diffraction analysis and is advantageous in that this crystal lattice has more slip planes, i.e. is more readily plastically deformable. This leads in particular to the first layer being plastically deformable without cracking and having a low deformation limit and a high elongation at break. However, the first layer may also be only partially austenitic or not austenitic at all, depending on the requirement of the buffering effect.

The thickness of the first layer depends on the minimum layer thickness required from the perspective of corrosion protection and on the requirements of the stress reduction. The thickness of the second layer depends on the requirements of the required service life of the component to be protected and the required friction resistance. Therefore, it is further preferred that the first layer has a thickness of 10 μm to 500 μm and/or the second layer has a thickness of 15 μm to 500 μm. By selecting said thicknesses, an optimal overall functionality of the coating is ensured.

In a preferred embodiment, the coating according to the invention has a third layer comprising an alloy containing aluminum and/or zinc, preferably consists of an alloy containing aluminum- and/or zinc-containing alloy or a lacquer, and is applied to the second layer. Such a design is advantageous for reasons of corrosion protection of the sections not provided with the coating and the area of the component to be protected (brake disc, brake drum, clutch disc or the like). It is, therefore, advantageous to cover the entire component to be protected with a further layer, including the coating already applied. At locations of the component where the first and second layers have already been applied, a third layer is thus added to the initially two-layer coating, which optionally also extends outside the regions with the first and second layers and directly covers the base body of the component to be protected. However, this additional layer is quickly removed on the friction surface during operation, and therefore the second (outer) layer re-emerges. A third layer based on aluminum or zinc can be applied, for example, by wire spraying, thermal spraying or dip coating.

The present invention and disclosure also includes that the first and second layers are not limited to production by means of thermal spraying, or only the first layer is a thermally sprayed layer and the second layer is not limited to one type of production. Specifically, another integral part of this invention is therefore a more general coating, in particular for brake discs, brake drums and clutch discs, which comprises a metal-based material, which contains less than 20% by weight tungsten carbide or other carbides, and a second layer, which is applied to the first layer and comprises a tungsten-carbide-containing material, which contains 20% by weight to 94% by weight tungsten carbide. In a further embodiment of the coating according to the invention, the coating is obtainable overall by thermal spraying methods, is preferably obtained thereby, and is further preferably a thermally sprayed coating. Thermally sprayed layers are advantageously characterized in that metallurgical interactions with the substrate to be coated hardly occur and technically advantageous compressive stresses can be realized in the coatings. From a technical point of view related to the process, there is an advantage to thermally spraying in particular the first layer and the second layer, in that both layers can be produced in one set-up, and therefore no process change and thus location change is necessary during production. This is different in the prior art, where the first layer is applied galvanically, but the second layer is applied by a different production method. In addition, it should be noted that thermal spraying methods are significantly more flexible than galvanic methods, and therefore allow more materials to be processed.

A further aspect of the present invention and disclosure is a method for producing the coating according to the invention. Preferably, at least the first and second layers are produced by thermal spraying. The first layer is then preferably generated from metal or alloy powders by means of an HVAF method (“High Velocity Air Fuel”) or a “Cold Spray” method, whereby the friction surface of the component to be protected is coated. Both methods have a sufficiently high spraying speed, and therefore the layer is correspondingly largely free of pores and cracks, even in the case of relatively thin layers. In addition, it is possible to generate advantageous compressive stresses in the first layer by admixing particles to the spray powder which are not or are hardly deposited during the spraying process. These particles, e.g. Al₂O₃ or SiC, additionally compress the layer on impact, and therefore already comparatively thin layer thicknesses lead to complete corrosion protection. The second layer is produced by means of HOVF or HVAF methods. Both methods are known to form coatings of sufficiently good quality with good deposition rates. The HVAF method is characterized by the at least partial use of air as oxidizing agent, whereby the particle velocity is significantly increased during thermal spraying. In contrast, oxygen is used in the HVOF process. The coating can thus preferably be produced in one production line and in one set-up. It is particularly preferred to produce both the first and the second layer by means of the HVAF method. Optionally, both the first layer and the second layer can be produced by a “warm spray” method. This method is described, for example, by KeeHyun Kim et al. in “Comparison of Oxidation and to Microstructure of Warm-Sprayed and Cold-Sprayed Titanium Coatings”, Journal of Thermal Spray Technology 2012, 21 (3-4), 550-560. Generally suitable spray systems for producing the coating according to the invention and the layers thereof are, for example, M2 and M3 from UniqueCoat (USA) or AK-06, AK-07 or C7 from Kermetico (USA).

Furthermore, the following spray parameter is conceivable for the thermal spraying of the first layer by means of the spray system C7:

| Propane: | 173 | Nl/min |
|---|---|---|
| Air: | 3342 | Nl/min |
| Oxygen: | 111 | Nl/min |
| Hydrogen: | 11 | Nl/min |
| Carrier gas (nitrogen): | 17.6 | Nl/min |
| Spraying distance: | 203 | mm |
| Nozzle: | 5E (275 mm long) | |
| Spray powder: | Fe Cr29 Ni10 Mo4 C1, 8, gas- | |
| | atomized, 45/11 μm | |
| Spray powder feed rate: | 4 | kg/h |

24% by weight silicon carbide (SiC)<600 mesh is mixed into the spray powder in order to compact the layer. Due to its high melting point, however, it is not deposited or is only rarely deposited and is therefore not, or hardly, found in the first layer. Instead, other oxides or carbides, such as Al₂O₃ (e.g. as fused aluminum oxide) or B₄C, can be used. There is extensive freedom of choice when selecting the spray parameters for the second layer.

The present invention and disclosure thus comprises a method for producing a coating, in particular for brake discs, brake drums and clutch discs, i.e. preferably the coating described above, wherein the first layer and/or the second layer of the coating is/are produced by thermal spraying. It is preferred that at least the first layer is thermally sprayed and, further preferably, the second layer is also thermally sprayed. It is preferred that the first layer of the coating according to the invention is applied to the base body or the friction surface of a component by thermal spraying, and the second layer of the coating according to the invention is then applied to the first layer, optionally also by thermal spraying. This results in a two-layer system consisting of two durably interconnected thermal spray layers. In a preferred embodiment, the first layer of the coating and/or the second layer of the coating is/are produced or applied by HVOF or HVAF or “cold spray” methods. In this case, it is particularly preferred that the first layer is produced/applied by means of an HVAF or “cold spray” method from metal or alloy powders and the second layer is produced or applied to the second layer by HVOF or HVAF methods from metal or alloy powders. This includes the option that different methods are specifically selected for the production or application of the first and the second layer in order to adjust the different property and requirement profiles.

A further aspect of the present invention and disclosure are concrete applications of the coating described above, in all of its embodiments and with all its effects and advantages. These applications thus also represent specific exemplary embodiments of the present invention.

Consequently, the present invention comprises a brake disc for a disc brake or a brake drum for a drum brake or a clutch disc for a clutch, having the coating described above, wherein the coating is at least partially, preferably completely, applied to the friction surfaces of the brake disc or of the brake drum or of the clutch disc. The brake disc, brake drum, and clutch disc mentioned here preferably relate to corresponding components known from the automotive context. Consequently, these are components for motor vehicles, such as passenger cars, trucks and motorcycles. Further included are flywheels of internal combustion engines with pressure couplings and friction linings. In the context of the present invention, the friction-loaded components, such as brake discs, brake drums or clutch discs, are therefore provided with the coating according to the invention in such a way that it can develop its advantageous effects. The base material or the base body of the components or the friction surfaces thereof which are to be protected form the physical base to which the coating is applied. The first layer forms the inner layer and is preferably applied directly to the base material or the base body. Furthermore, the second layer is applied to the first layer, which second layer is the outermost layer in the case of a two-layer coating and comes into contact with the friction partner. Optionally, the third layer described above can also be applied to the second layer.

Consequently, a preferred embodiment consists in the first layer being applied directly to the friction surface, and the second layer is applied to the first layer and, optionally, the third layer is applied to the second layer. However, the present invention also relates to components, e.g. brake disc, brake drum, clutch disc, which are provided at least partially, locally with the coating according to the invention, wherein uncoated portions and surfaces are optionally provided at least with the third layer (Al, Zn or lacquer layer) for temporary protection, in particular corrosion protection.

In addition to the individual components specified above, the overall systems in which they are used also form an integral part of this invention and disclosure. Specifically, a disc brake or a drum brake or a clutch or a clutch system, which appropriately in each case have the brake disc in the case of a disc brake or the brake drum in the case of a drum brake or the clutch disc in the case of a clutch as described above and contain it as a system component.

A final aspect of the present invention and disclosure is the use of the previously described coating in all of its embodiments and with all of its effects and advantages for coating brake discs for disc brakes or for coating brake drums for drum brakes or for coating clutch discs for clutches, i.e. for coating the previously described, preferably automotive, components.

### Exemplary Embodiment

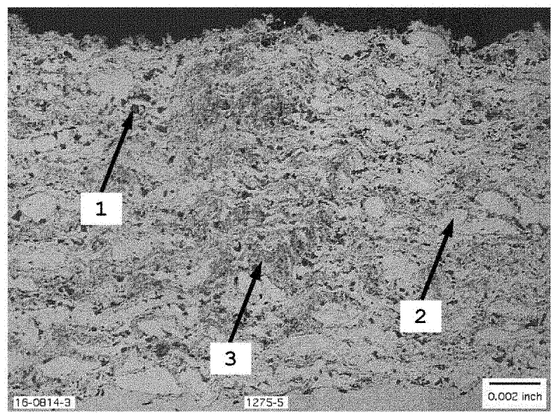

FIG. 1 shows by way of example a microscopic cross-sectional image of the first layer as a constituent of the coating according to the invention. This was generated by means of an HVAF method. The dark gray image components represent SiC particles as hardness carrier or as carbide 1 in a matrix formed from the metal-based material 2, which matrix is represented by light gray image components. Oxides 3, which formed as a result of the thermal spraying process, appear in FIG. 1 as medium-gray image components. It can be clearly seen that the first layer is compact and dense and exhibits neither cracks nor pores in the microscopic representation.

1. A coating comprising:
a first layer, which comprises a metal-based material, which contains less than 20% by weight tungsten carbide or other carbides, and
a second layer, which is applied to the first layer and comprises a tungsten-carbide-containing material, which contains 20% by weight to 94% by weight tungsten carbide, wherein
the first and second layers are thermally sprayed coatings.

2. The coating according to claim 1, wherein
the first layer consists of the metal-based material, and/or
the second layer consists of the tungsten-carbide-containing material.

3. The coating according to claim 1, wherein
the coating overall has a service life of over 1000 h in the salt spray test according to ASTM B 117, and/or
the first layer is a substantially dense, pore- and crack-free layer and the second layer has cracks and pores which are continuous in the layer thickness direction.

4. The coating according to claim 1, wherein
the metal-based material of the first layer comprises iron and/or nickel and/or chromium, and/or
the tungsten-carbide-containing material of the second layer comprises iron, cobalt, nickel, chromium and/or aluminum or alloys of said elements.

5. The coating according to claim 1, wherein
the first layer is stably austenitic at room temperature, and/or
the first layer has a thickness of 10 μm to 500 μm, and/or
the second layer has a thickness of 15 μm to 500 μm.

6. The coating according to claim 1, further comprising a third layer which comprises an alloy containing aluminum and/or zinc, wherein the third layer is applied to the second layer.

7. The coating according to claim 1, wherein the coating as a whole can be obtained, by thermal spraying methods.

8. A brake disc for a disc brake or brake drum for a drum brake or clutch disc for a clutch, comprising the coating according to claim 1, wherein the coating is at least partially applied to the friction surfaces of the brake disc or of the brake drum or of the clutch disc.

9. The brake disc or brake drum or clutch disc according to claim 8, wherein the first layer is applied directly to the friction surface, and the second layer is applied to the first layer and, optionally, the third layer is applied to the second layer.

10. A disc brake or drum brake or clutch, comprising the brake disc or the brake drum or the clutch disc according to claim 8.

11. A method for producing a coating according to claim 1, wherein a first layer and/or a second layer of the coating is/are produced by thermal spraying.

12. The method according to claim 11, wherein
at least the first layer is thermally sprayed and optionally also the second layer is thermally sprayed, and/or
the first layer is applied to a base body or a friction surface of a component by thermal spraying, and the second layer is then applied to the first layer, optionally also by thermal spraying.

13. The method according to claim 11, wherein the first layer and/or the second layer is/are produced or applied by HVOF or HVAF or “cold spray” methods.

14. A use of a coating according to claim 1, for coating brake discs for disc brakes or for coating brake drums for drum brakes or for coating clutch discs for clutches.
